(19) United States
(12) Patent Application Publication
(10) Pub. No.: US 2024/0100978 A1
(43) Pub. Date: Mar. 28, 2024

(54) VEHICLE ON-BOARD BATTERY CHARGER AND CONTROLLER FOR SAME

(71) Applicant: Lear Corporation, Southfield, MI (US)

(72) Inventors: Jordi BATLLE PORTO, Valls (ES); Adria MARCOS PASTOR, Valls (ES); Sergio MARTINEZ PORRAS, Valls (ES)

(73) Assignee: Lear Corporation, Southfield, MI (US)

(21) Appl. No.: 17/935,414

(22) Filed: Sep. 26, 2022

(51) Int. Cl. B60L 53/20; B60L 53/62; H02M 1/00

(52) U.S. Cl. CPC B60L 53/20; B60L 53/62; H02M 1/007; B60L 2210/10

(57) ABSTRACT

A charger includes multiple rails, each rail having a power factor correction (PFC) module, a direct current (DC) link capacitor, and a DC-to-DC voltage converter. The charger also includes a controller that deactivates a subset of the rails in response to an electrical load having a power consumption less than a threshold power, where deactivation of the subset of rails includes deactivation of the PFC module and the DC-to-DC voltage converter of each rail of the subset of rails. For each rail of the deactivated subset of the plurality of rails, the controller activates the PFC module when a voltage of the DC link capacitor equals a threshold voltage.

### TECHNICAL FIELD

The present disclosure relates to a vehicle on-board battery charger for charging a vehicle battery and a controller for a vehicle on-board battery charger.

### BRIEF DESCRIPTION OF THE DRAWINGS

FIGS. 1A and 1B are simplified block diagrams of an electric vehicle including non-limiting, exemplary embodiments of an on-board battery charger;

FIG. 2 is a simplified block diagram of a non-limiting, exemplary rail of the vehicle on-board battery charger of FIG. 1A;

FIGS. 3A and 3B are simplified block diagrams of non-limiting, exemplary embodiments of a single rail of a vehicle on-board battery charger according to the present disclosure; and

FIG. 4 is graph of a direct current (DC) link capacitor voltage over time according to a non-limiting, exemplary embodiment of a control methodology for a vehicle on-board battery charger according to the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, features, and elements have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” and/or “at least one” includes a function being performed by one element, a function being performed by more than one element, e.g., in a distributed fashion, several functions being performed by one element, several functions being performed by several elements, or any combination of the above.

It, will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” is, optionally, construed to mean “when” or “upon” or “in response to determining or “in response to detecting,” depending on the context. Similarly, the phrase “if it is determined” or “if [a stated condition or event] is detected” is, optionally, construed to mean “upon determining” or “in response to determining” or upon detecting [the stated condition or event]” or “in response to detecting [the stated condition or event],” depending on the context.

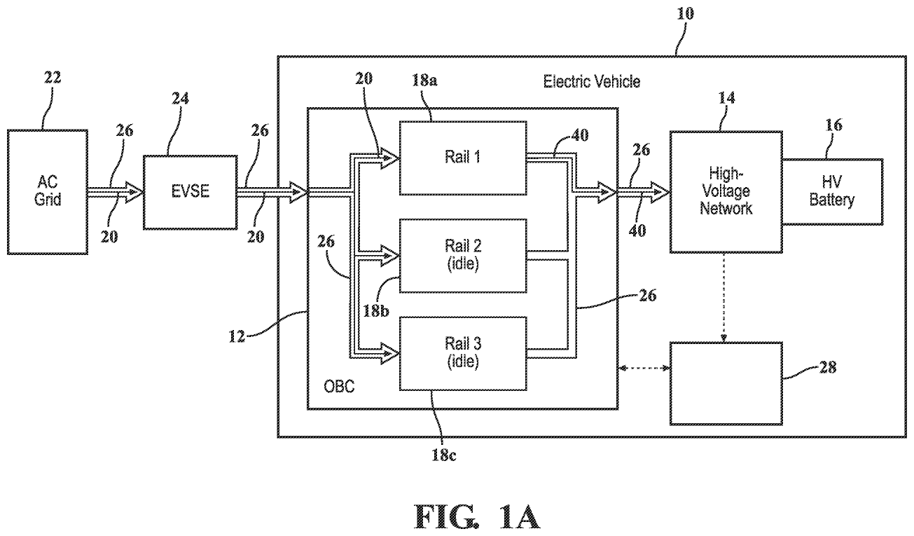

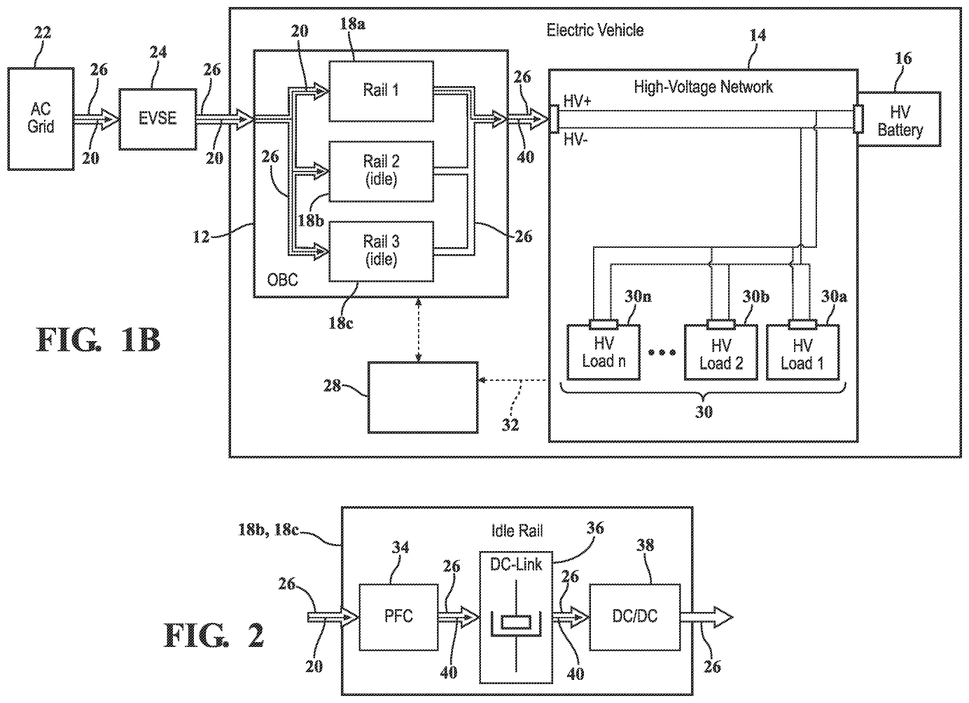

FIGS. 1A and 1B are simplified block diagrams of an electric vehicle including non-limiting, exemplary embodiments of an on-board battery charger. In that regard, FIG. 1B illustrates further details of the high-voltage network shown in FIG. 1A. FIG. 2 is a simplified block diagram of a non-limiting, exemplary embodiment of a rail of the vehicle on-board battery charger of FIG. 1A.

As seen therein, according to the embodiment or embodiments shown, an electric vehicle (EV) 10 comprises a vehicle on-board battery charger (OBC) 12 connected to a high-voltage network 14 and a high-voltage (HV) DC battery 16. As used herein, the term high-voltage includes any voltage greater than or equal to 60 volts. The OBC 12 comprises a plurality, specifically three (3), of internal rails 18a, 18b, 18c connected in parallel for receiving three-phase power 20 from an Alternating Current (AC) electric power grid 22 via Electric Vehicle Supply Equipment (EVSE) 24 over conductors 26. It is noted that mono-phase input may also be accepted by adapting input interconnections. In that regard, the rails 18a, 18b, 18c act as and/or comprise power converter and/or supply circuits as described herein. Operation of the OBC 12 is controlled by a controller 28 provided in electrical communication with the OBC 12.

The HV battery 16 of the EV 10 is configured to power an electrical load 30 of the EV 10. In that regard, it is also noted that a load might be both the battery 16 or any other electronic HV-unit 30a, 30b, 30n in the system to be active while charging the battery 16. Under light load conditions, the controller 28 controls the OBC 12 to deactivate or idle one or more of the internal rails 18b, 18c by deactivating DC-to-DC converter 38. In that regard, light load conditions may comprise conditions in which the electrical power consumed by the load 30 is less than or equal to a threshold power. Such power consumption by the load 30 may be measured and/or determined based a setpoint of power to be supplied by the system (i.e., the voltage and current values the system needs and requests the OBC 12 to provide) that is representative or indicative of the electrical power consumed by the load 30, and which may be received as external commands that arrive through a digital bus 32 provided in electrical communication with the controller 28. The OBC 12 also measures the output voltage and the output current as supplied to the HV network 14.

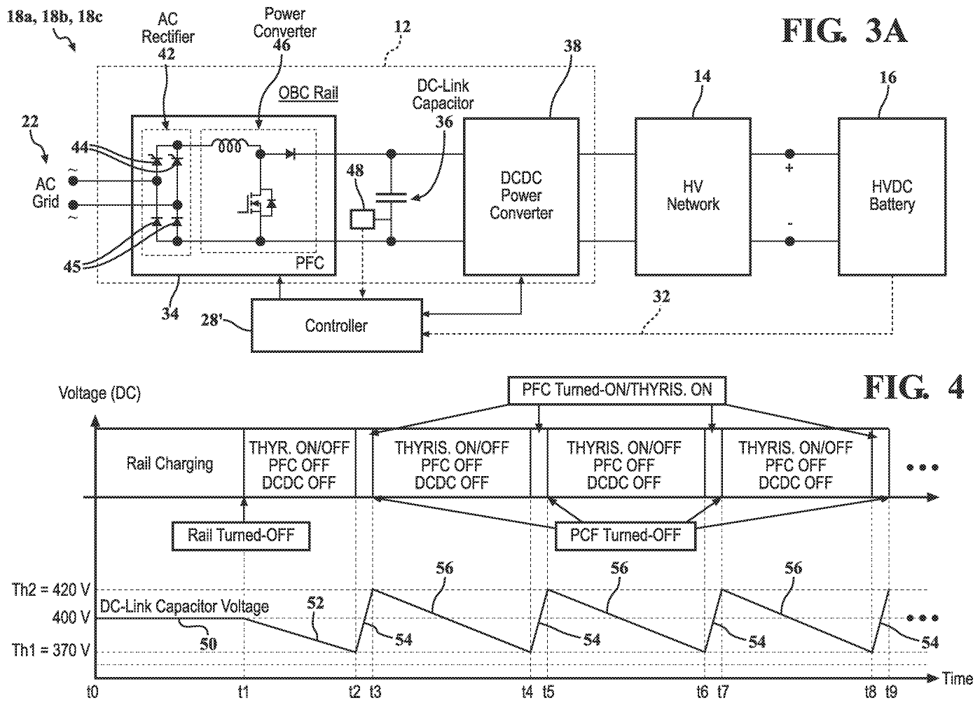

Each rail 18a, 18b, 18c of the OBC 12 comprises a Power Factor Correction (PFC) module 34, a DC link capacitor 36, and an DC-to-DC power converter 38. In that regard, such components are illustrated in FIG. 2 in connection with an idle rail 18b or 18c. As is understood by those of ordinary skill, the PFC module 34 comprises a circuit including an AC rectifier and a power or voltage converter (see FIGS. 3A and 3B), the DC link capacitor 36 may comprise a bulk capacitor, and the DC-to-DC converter 38 may comprise or work as a buck or as a boost circuit. In that regard, the DC-to-DC stage 38 may perform both buck or boost conversion, depending on the input AC 22 (e.g., 110 volts, 220 volts), the nominal value of DC-Link 36 voltage, and current battery 16 voltage.

As previously described, under light load conditions, the controller 28 controls the OBC 12 to deactivate or idle one or more of the internal rails 18b, 18c by deactivating the DC-to-DC converter 38. After such deactivation of rails 18b, 18c, active rail 18a continues to receive and convert AC input energy 20 to DC energy 40 to supply the High-Voltage network 14 and the HV battery 16 of the EV 10. As seen in FIGS. 1 and 2, deactivated or idle rails 18b, 18c continue to receive AC input energy 36, which is still transferred by PFC module 34 to DC energy 40 that reaches the DC-Link capacitor 36 and the DC-to-DC converter 38. As a result, in the event of an overvoltage occurring on or being supplied by the AC-grid 22, the DC-Link capacitor 36 receives a stressing current peak that reduces the lifetime of components or might even damage them. In that regard, it is noted that while the PFC module 34 is not active (because the transistor of the Power Converter 46 is OFF), the PFC module 34 is the path through the inductor and the diode shown that enable the energy to flow to the DC-Link 36 (see FIGS. 3A and 3B).

FIGS. 3A and 3B are simplified block diagrams of non-limiting, exemplary embodiments of a single rail (18a, 18b, or 18c) of a vehicle on-board battery charger (OBC) 12 according to the present disclosure. In that regard, FIG. 3B illustrates further details of the high-voltage network 14 shown in FIG. 3A. As seen therein, and as previously described and understood by those of ordinary skill, the PFC module 34 comprises an AC rectifier circuit 42 comprising a plurality of thyristors 44 and diodes 45 for rectifying AC voltage supplied by the AC-grid 22 to a DC voltage, and a power or voltage converter circuit 46 for boosting the voltage of the rectified current generated by the rectifier circuit 42. Power from the power converter circuit 46 is stored by the DC link capacitor 36 and delivered DC-to-DC power or voltage converter circuit 38, which in turn supplies to the High-Voltage network 14 for charging the HV DC battery 16. In that regard, according to the present disclosure, a controller 28′ is configured to control the PFC module 34, including the rectifier circuit 42 and the power converter circuit 46, as described herein. According to the present disclosure, the controller 28′ is also configured as described herein to control the DC-to-DC power converter 38, which may include converting (e.g., boost and/or buck) the DC voltage received from the DC link capacitor 38 to be supplied to the High-Voltage network 14.

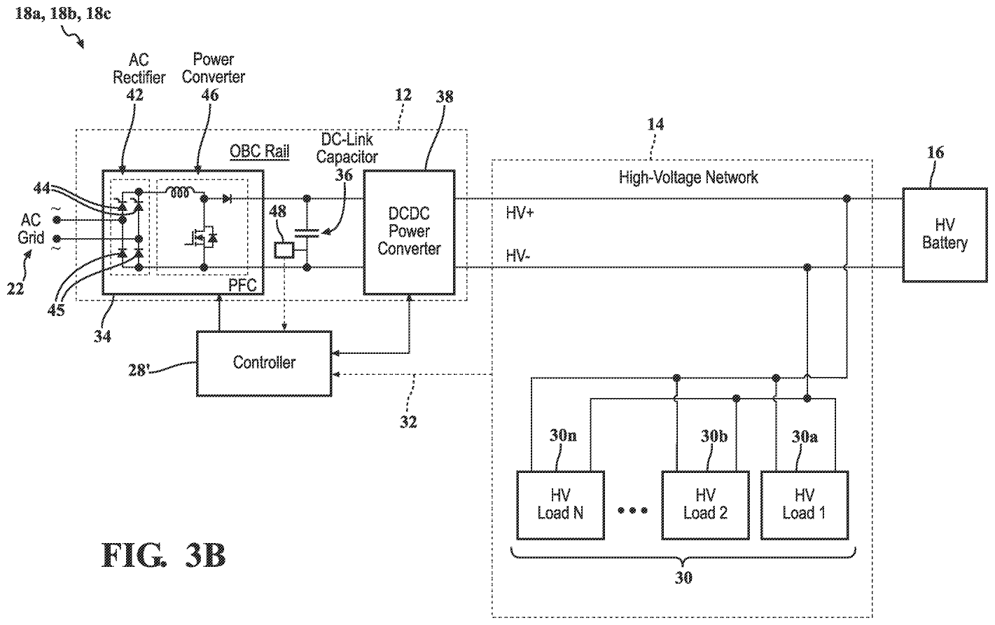

In that regard, FIG. 4 is graph of a voltage of a direct current (DC) link capacitor 36 over time according to a non-limiting, exemplary embodiment of a control methodology for a vehicle on-board battery charger (OBC) 12 according to the present disclosure. As seen therein and with continuing reference to FIGS. 1-3, while in operation, a DC link capacitor 36 works at a (DC) voltage higher than the AC voltage of the AC-grid 22. For example, the DC link capacitor 36 may work at 400 volts, as compared to an AC voltage of 240 volts of the AC-grid 22. In deactivated rails 18b, 18c, idled in response to a light load condition, the DC link capacitor 36 would ordinarily discharge, due to internal losses, to voltage of the AC-grid 22. As previously described, such discharge may render the DC link capacitor 36 susceptible to an overvoltage occurring on or being supplied by the AC-grid 22, whereby the DC-Link capacitor 36 receives a stressing current peak passing through the components of the PFC stage 34 that reduces the lifetime of the components or may cause damage.

In contrast, according to the present disclosure, the voltage of the DC link capacitor 36 is maintained at a voltage higher than any voltage of the AC-grid 22, including any possible grid overvoltage thereof, which may be repetitive and thus have more of an aging effect on components in the long run. This is accomplished by means of short periods (i.e., bursts) of re-charging of the DC link capacitor 36 of each idled rail 18a, 18b, or 18c. Such charging bursts are accomplished by activating the PFC stage or PFC module 34, wherein the thyristors 44 of the rectifier circuit 42 are turned ON or activated, and the power converter circuit 46 is operated in a voltage boost mode. Burst periods are controlled by the controller 38′ by comparing a sensed, measured, or determined voltage of the DC link capacitor 36 with two threshold voltages (Th1 and Th2). In that regard, each rail 18a, 18b, 18c includes a sensor 48 for sensing, measuring, or determining a voltage of the DC link capacitor 36 thereof and transmitting a signal indicative of such sensed, measured, or determined voltage of the DC link capacitor 36 to the controller 28′.

In that regard, as seen in FIG. 4, during a time period from time t0 to t1, a rail is charging and the DC link capacitor 36 thereof has a sensed, measured, or determined voltage level 50 of 400 volts. At time t1, in response to a light load condition, a subset of the rails (e.g., one or more) 18a, 18b, 18c is turned off, deactivated, or idled by the controller 28′. In that regard, according to the present disclosure, the PFC module 34 is deactivated, wherein the thyristors 44 of the rectifier circuit 42 are turned OFF or deactivated and the power converter circuit 46 is turned OFF or deactivated, and the DC-to-DC power converter 38 is turned OFF or deactivated.

As a result, the DC link capacitor 36 begins to discharge and the voltage level 52 thereof begins to fall and/or decreases. According to the present disclosure, at time t2 when the voltage level 52 of the DC link capacitor 36 decreases to or reaches a first threshold Th1 of 370 volts, the controller 28′ activates the PFC module 34 of the idled rail (e.g., 18c), wherein the thyristors 44 of the rectifier circuit 42 are turned ON or activated and the power converter circuit 46 is also turned ON or activated. The DC-to-DC power converter circuit 38 however remains turned OFF or deactivated. While not preferred, not preferred, thyristors 44 in the rectifier circuit 42 could be kept ON.

In response, the DC link capacitor 36 begins to charge and the voltage level 54 thereof begins to rise and/or increases. According to the present disclosure, at time t3 when the voltage level 54 of the DC link capacitor 36 increases to or reaches a second threshold Th2 of 420 volts, the controller 28′ deactivates the PFC module 34 of the idled rail (e.g., 18c), wherein the thyristors 44 of the rectifier circuit 42 are turned OFF or deactivated and the power converter circuit 46 is turned OFF or deactivated. The DC-to-DC power converter circuit 38 again remains turned OFF or deactivated.

As a result, the DC link capacitor 36 begins to discharge again and the voltage level 56 thereof again begins to fall and/or decreases. According to the present disclosure, at time t4 when the voltage level 56 of the DC link capacitor 36 decreases to or reaches the first threshold Th1 of 370 volts, the controller 28′ activates the PFC module 34 of the idled rail (e.g., 18c), wherein the thyristors 44 of the rectifier circuit 42 are turned ON or activated and the power converter circuit 46 is also turned ON or activated. The DC-to-DC power converter circuit 38 remains turned OFF or deactivated.

As seen in FIG. 4, according to the present disclosure, the controller 28′ controls similar discharge and charge cycles of the DC link capacitor 36 of an idle rail or rails 18b, 18c of the OBC 12 and the changing voltage levels thereof as described above in repeating and/or alternating fashion from times t5 to t6 (discharge (56)), t6 to t7 (charge (54), t7 to t8 (discharge (56)), t8 to t9 (charge (54)), etc. As also seen therein, the charge times (e.g., t2 to t3, t4 to t5, t6 to t7, and t8 to t9) of the DC link capacitor 36 are shorter in duration than the discharge times (e.g., t1 to t2, t3 to t4, t5 to t6, and t7 to t8) thereof. Such charge times and charging of the DC link capacitor 36 according to the present disclosure may therefore be described as “burst” charging or “burst” operation of the PFC modules 24 in the idle rails 18b, 18c of the OBC 12.

It is noted that the previously described operating voltage of 400 volts for the DC link capacitor 36, the first threshold voltage Th1 of 370 volts, and the second threshold voltage Th2 of 420 volts are exemplary only and other operating and threshold voltage levels or values could alternatively be employed. In that regard, according to the present disclosure, the first threshold Th1 voltage is less than the operating voltage of the DC link capacitor 36. The first threshold voltage Th1 is also greater than the nominal voltage of the AC-grid 22, including any possible overvoltage condition that may transiently occur in the AC-grid 22. The second threshold voltage Th2 is also equal to or greater than the operating voltage of the DC link capacitor 36 and greater than the first threshold voltage Th1. It is also noted that, as there are different AC grid standards in the world, the OBC 12 may adapt the threshold values Th1, Th2 depending on the particular AC grid 22 being connected as the input source, and the battery voltage in the vehicle. In such a fashion, a single OBC model may be applied in a platform of cars supplied with different HV Batteries.

The present disclosure described herein thus provides burst activation of a PFC stage in idle OBC rails in order to keep DC-Link voltage high over any AC-grid overvoltage. According to the present disclosure as described herein, while in light load conditions and some OBC rails in stand-by (idle), each respective DC-Link voltage of an idle rail is measured. When the DC link voltage falls to or below a defined first threshold, the boost charging of the PFC stage (burst) of the idle rail is activated until the DC link voltage reaches a second voltage threshold, at which time the PFC stage is then switched OFF. In such a fashion, the present disclosure prevents over-stress to rail components which may be caused by DC-link high in-rush currents. Moreover, the present disclosure does so without requiring an input relay and resistor to limit capacitor in-rush current, thereby avoiding the expense and added weight associated with such additional components.

As those skilled in the art will understand, the controller 28′, as well as any other component, system, subsystem, unit, module, interface, sensor, device, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof, any component, system, subsystem, unit, module, interface, sensor, device, or the like described herein, and/or for performing the particular algorithm or algorithms represented by the various methods, functions and/or operations described herein, including interaction between and/or cooperation with each other.

The present disclosure thus provides burst PFC operation in OBC idle rails that provides protection against in-rush currents of standby (idle) phases which are supplied with AC voltage, for improved OBC robustness. The present disclosure thereby provides a more controlled aging model of the rectifier and PFC semiconductors as well as the bulk capacitor. The present disclosure does so with a suitably programmed controller rather than requiring the addition or change of any OBC or other component hardware. The present disclosure thereby represents an improved OBC that prevents failures and/or prevents or mitigates effects of over-stresses.

Item 1: In one embodiment, the present disclosure provides a charger comprising (i) a plurality of rails, each rail comprising a power factor correction (PFC) module, a direct current (DC) link capacitor, and a DC-to-DC voltage converter, and (ii) a controller that deactivates a subset of the plurality of rails in response to an electrical load having a power consumption less than a threshold power, wherein deactivation of the subset of the plurality of rails comprises deactivation of the PFC module and the DC-to-DC voltage converter of each of the subset of the plurality of rails, and wherein, for each rail of the deactivated subset of the plurality of rails, the controller activates the PFC module when a voltage of the DC link capacitor equals a threshold voltage.

Item 2: In another embodiment, the present disclosure provides the charger according to item 1 wherein the threshold voltage has a value greater than a value of a voltage of a power source supplying the charger.

Item 3: In another embodiment, the present disclosure provides the charger according to Item 1 or Item 2 wherein, for each rail of the deactivated subset of the plurality of rails, after activation of the PFC module when the voltage of the DC link capacitor equals the threshold voltage, the controller deactivates the PFC module when the voltage of the DC link capacitor equals another threshold voltage greater than the threshold voltage.

Item 4: In another embodiment, the present disclosure provides the charger according to any of Items 1-3 wherein, for each rail of the deactivated subset of the plurality of rails, a duration of each deactivation of the PFC module exceeds a duration of each activation of the PFC module.

Item 5: In another embodiment, the present disclosure provides the charger according to any of Items 1-4 wherein, for each rail of the deactivated subset of the plurality of rails, the controller alternately activates and deactivates the PFC module.

Item 6: In another embodiment, the present disclosure provides the charger according to any of Items 1-5 wherein, for each rail of the deactivated subset of the plurality of rails, a duration of each deactivation of the PFC module exceeds a duration of each activation of the PFC module.

Item 7: In another embodiment, the present disclosure provides the charger according to any of Items 1-6 wherein, for each rail of the deactivated subset of the plurality of rails, the voltage of the DC link capacitor decreases to the threshold voltage.

Item 8: In another embodiment, the present disclosure provides the charger according to any of Items 1-7 wherein, for each rail of the deactivated subset of the plurality of rails, the controller receives a signal indicative of a value of the voltage of the DC link capacitor and compares the value of the DC link capacitor voltage to the voltage threshold.

Item 9: In another embodiment, the present disclosure provides the charger according to any of Items 1-8 wherein, for each rail of the deactivated subset of the plurality of rails, the voltage of the DC link capacitor increases to the another threshold voltage.

Item 10: In another embodiment, the present disclosure provides the charger according to any of Items 1-9 wherein, for each rail of the deactivated subset of the plurality of rails, the controller receives a signal indicative of a value of the voltage of the DC link capacitor and compares the value of the DC link capacitor voltage to the another voltage threshold.

Item 11: In another embodiment, the present disclosure provides the charger according to any of Items 1-10 wherein the charger comprises a vehicle on-board charger (OBC) for charging a vehicle battery.

Item 12: In another embodiment, the present disclosure provides the charger according to any of Items 1-11 wherein, for each rail of the plurality of rails, the PFC module comprises (i) a rectifier circuit that rectifies a voltage supplied by an alternating current (AC) power source and (ii) a voltage converter circuit that increases a level of the rectified voltage.

Item 13: In another embodiment, the present disclosure provides the charger according to any of Items 1-12 wherein the rectifier circuit comprises a plurality of thyristors.

Item 14: In another embodiment, the present disclosure provides the charger according to any of Items 1-13 wherein the electrical load is powered by a vehicle battery, and the controller receives a setpoint of output power supplied which is indicative of a value of the power consumption and compares the value of the power consumption to the threshold power.

Item 15: In another embodiment, the present disclosure provides a vehicle comprising the charger according to any of Items 1-14.

Item 16: In another embodiment, the present disclosure provides a non-transitory computer readable storage medium having stored computer executable instructions for controlling a vehicle battery charger comprising a controller and a plurality of rails, each rail comprising a power factor correction (PFC) module, a direct current (DC) link capacitor, and a DC-to-DC voltage converter, wherein execution of the computer executable instructions causes the controller to (i) deactivate the PFC module and the DC-to-DC voltage converter of each of a subset of the plurality of rails in response to an electrical load having a power consumption less than a threshold power to thereby deactivate the subset of the plurality of rails, and (ii) activate, for each rail of the deactivated subset of the plurality of rails, the PFC module when a voltage of the DC link capacitor equals a threshold voltage.

Item 17: In another embodiment, the present disclosure provides the non-transitory computer readable storage medium according to Item 16 wherein the threshold voltage has a value greater than a value of a voltage of a power source supplying the charger.

Item 18: In another embodiment, the present disclosure provides the non-transitory computer readable storage medium according to Item 16 or Item 17 wherein, for each rail of the deactivated subset of the plurality of rails, after activation of the PFC module when the voltage of the DC link capacitor equals the threshold voltage, execution of the computer executable instructions further causes the controller to deactivate the PFC module when the voltage of the DC link capacitor equals another threshold voltage greater than the threshold voltage.

Item 19: In another embodiment, the present disclosure provides the non-transitory computer readable storage medium according to any of Items 16-18 wherein, for each rail of the deactivated subset of the plurality of rails, execution of the computer executable instructions further causes the controller to alternately activate and deactivate the PFC module.

Item 20: In another embodiment, the present disclosure provides the non-transitory computer readable storage medium according to any of Items 16-19 wherein, for each rail of the deactivated subset of the plurality of rails, a duration of each deactivation of the PFC module exceeds a duration of each activation of the PFC module.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, unless the context clearly indicates otherwise, the various features, elements, components, methods, procedures, steps, and/or functions of various implementing embodiments may be combined or utilized in any combination or combinations and/or may be performed in any order other than those specifically described herein to form further embodiments according to the present disclosure.

What is claimed is:

1. A charger comprising:
a plurality of rails, each rail comprising a power factor correction (PFC) module, a direct current (DC) link capacitor, and a DC-to-DC voltage converter; and
a controller that deactivates a subset of the plurality of rails in response to an electrical load having a power consumption less than a threshold power, wherein deactivation of the subset of the plurality of rails comprises deactivation of the PFC module and the DC-to-DC voltage converter of each of the subset of the plurality of rails;
wherein, for each rail of the deactivated subset of the plurality of rails, the controller activates the PFC module when a voltage of the DC link capacitor equals a threshold voltage.

2. The charger according to claim 1 wherein the threshold voltage has a value greater than a value of a voltage of a power source supplying the charger.

3. The charger according to claim 1 wherein, for each rail of the deactivated subset of the plurality of rails, after activation of the PFC module when the voltage of the DC link capacitor equals the threshold voltage, the controller deactivates the PFC module when the voltage of the DC link capacitor equals another threshold voltage greater than the threshold voltage.

4. The charger according to claim 3 wherein, for each rail of the deactivated subset of the plurality of rails, a duration of each deactivation of the PFC module exceeds a duration of each activation of the PFC module.

5. The charger according to claim 3 wherein, for each rail of the deactivated subset of the plurality of rails, the controller alternately activates and deactivates the PFC module.

6. The charger according to claim 5 wherein, for each rail of the deactivated subset of the plurality of rails, a duration of each deactivation of the PFC module exceeds a duration of each activation of the PFC module.

7. The charger according to claim 1 wherein, for each rail of the deactivated subset of the plurality of rails, the voltage of the DC link capacitor decreases to the threshold voltage.

8. The charger according to claim 7 wherein, for each rail of the deactivated subset of the plurality of rails, the controller receives a signal indicative of a value of the voltage of the DC link capacitor and compares the value of the DC link capacitor voltage to the voltage threshold.

9. The charger according to claim 3 wherein, for each rail of the deactivated subset of the plurality of rails, the voltage of the DC link capacitor increases to the another threshold voltage.

10. The charger according to claim 9 wherein, for each rail of the deactivated subset of the plurality of rails, the controller receives a signal indicative of a value of the voltage of the DC link capacitor and compares the value of the DC link capacitor voltage to the another voltage threshold.

11. The charger according to of claim 1 wherein the charger comprises a vehicle on-board charger (OBC) for charging a vehicle battery.

12. The charger according to claim 1 wherein, for each rail of the plurality of rails, the PFC module comprises (i) a rectifier circuit that rectifies a voltage supplied by an alternating current (AC) power source and (ii) a voltage converter circuit that increases a level of the rectified voltage.

13. The charger according to claim 12 wherein the rectifier circuit comprises a plurality of thyristors.

14. The charger according to claim 1 wherein the electrical load is powered by a vehicle battery, and the controller receives a setpoint of output power supplied which is indicative of a value of the power consumption and compares the value of the power consumption to the threshold power.

15. A vehicle comprising the charger according to claim 1.

16. A non-transitory computer readable storage medium having stored computer executable instructions for controlling a vehicle battery charger comprising a controller and a plurality of rails, each rail comprising a power factor correction (PFC) module, a direct current (DC) link capacitor, and a DC-to-DC voltage converter, wherein execution of the computer executable instructions causes the controller to:
deactivate the PFC module and the DC-to-DC voltage converter of each of a subset of the plurality of rails in response to an electrical load having a power consumption less than a threshold power to thereby deactivate the subset of the plurality of rails; and
activate, for each rail of the deactivated subset of the plurality of rails, the PFC module when a voltage of the DC link capacitor equals a threshold voltage.

17. The non-transitory computer readable storage medium according to claim 16 wherein the threshold voltage has a value greater than a value of a voltage of a power source supplying the charger.

18. The non-transitory computer readable storage medium according to claim 16 wherein, for each rail of the deactivated subset of the plurality of rails, after activation of the PFC module when the voltage of the DC link capacitor equals the threshold voltage, execution of the computer executable instructions further causes the controller to deactivate the PFC module when the voltage of the DC link capacitor equals another threshold voltage greater than the threshold voltage.

19. The non-transitory computer readable storage medium according to claim 18 wherein, for each rail of the deactivated subset of the plurality of rails, execution of the computer executable instructions further causes the controller to alternately activate and deactivate the PFC module.

20. The non-transitory computer readable storage medium according to claim 19 wherein, for each rail of the deactivated subset of the plurality of rails, a duration of each deactivation of the PFC module exceeds a duration of each activation of the PFC module.
